(19) United States
(12) Patent Application Publication
(10) Pub. No.: US 2026/0367962 A1
(43) Pub. Date: Nov. 19, 2026

(54) COORDINATION OF AGENTIC WORKFLOWS IN MULTI-AGENT ENVIRONMENTS

(71) Applicant: Microsoft Technology Licensing, LLC, Redmond, WA (US)

(72) Inventors: Sanjay RAMANUJAN, Redmond, WA (US); Karthik RAMAN, Sammamish, WA (US); Salman Mohammad QUAZI, Pleasanton, CA (US); Suriya Prakash KALIVARDHAN, Bellevue, WA (US); Dharamendra KUMAR, San Jose, CA (US); Ravi Teja PIDAPARTHI, Fremont, CA (US)

(21) Appl. No.: 19/211,608

(22) Filed: May 19, 2025

(51) Int. Cl. G06F 9/48; G06F 9/451

(52) U.S. Cl. CPC G06F 9/4843; G06F 9/451

(57) ABSTRACT

A disclosed agentic system includes a plurality of agents configured to coordinate control of a conversational interface based on transitions between a plurality of state machine states. Each of the states has a designated an agent control group comprising one or more agents selected from the plurality of agents that is responsible for acting on inputs received through the conversational interface while the state machine is in the state. The state machine is further defined by a plurality of permissible state transitions between pairs of the states, with each state-to-state transition being triggered by satisfaction of a different set of transition criteria. The plurality of agents are individually configured to evaluate the transition criteria and selectively transfer control of the conversational interface among the agent control groups defined for different states as state transitions are triggered by satisfaction of the transition criteria.

### BACKGROUND

It is common to train language models in a domain-specific manner, allowing different models to acquire domain-specific knowledge. An artificial intelligence (AI) agent is a system that uses AI logic to power its decisions, but that additionally includes logic, memory, and control flow. For example, an AI agent could include a domain-specific language model and one or more software tools capable of interacting with the language model to acquire knowledge that it then uses to carry out a domain-specific task, such as booking a flight, autonomously driving a car, autonomously generating and testing code, etc. Some AI agents integrate with external tools and services to perform complex tasks.

A system with multiple interconnected AI agents specializing in different domain-specific tasks could, in theory, be leveraged to provide powerful automation. For example, a multi-agent “computer assistant” system could include a first agent capable of understanding directory structures and acquiring different types of information, a second agent capable of generating and autonomously executing driver commands on the operating system kernel, another agent trained to generate and execute API calls to third-party endpoints, etc.

Presently, some model architectures utilize multi-agent systems to carry out workflows. However, the agents in these existing systems are typically individually programmed and require very specific input instructions. Typically, implementing these systems requires hiring a skilled developer to write code that controls agent coordination operations (e.g., code that describes which agents work together and how). These existing solutions are lack scalability and are prone to security vulnerabilities—particularly in relation to sensitive data being passed between agents.

### SUMMARY

According to one implementation, an agentic system includes a plurality of agents configured to coordinate tasks of a workflow based on transitions between different states of a state machine. Each of the state machine states has a designated agent control group identifying one or more of the plurality of agents as responsible for acting on inputs received through a conversational interface while the state machine is in the state. Transitions between pairs of the state machine states depend upon different sets of transition criteria. The plurality of agents configured to independently evaluate the transition criteria (e.g., when in control of the state machine and conversational interface) and selectively transfer control of the conversational interface among the agent control groups defined for the different states in response to state-to-state transitions of the state machine.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates aspects of an example agentic system that uses a state machine to coordinate the actions of multiple different agents.

FIG. 2 illustrates example state machine data that is stored as part of a state machine used to coordinate multi-agent workflows in an example agentic system.

FIG. 3 illustrates example operations for providing a multi-agent workflow.

FIG. 4 illustrates an example schematic of a processing device suitable for implementing aspects of the disclosed technology.

### DETAILED DESCRIPTION

The technology disclosed herein relates to a scalable framework to support agentic workflows that leverage the capabilities of multiple agents, each with specialized skills, to perform complex tasks in a coordinated manner. The term agentic workflow refers to a process where software agents—especially AI-powered agents—autonomously plan, make decisions, and take actions to achieve a goal with minimal human intervention. Agentic workflows represent a significant advancement in the field of artificial intelligence and automation. The concept of agentic workflows is rooted in the idea of creating intelligent systems that can interact with users, process information, and execute actions autonomously.

Traditional multi-agent AI systems often struggle with scalability and performance, especially when dealing with complex tasks that require coordination between multiple agents. Within these environments, it is common to employ a tree-like hierarchy of agents in which higher-level agent(s) delegate tasks to lower-level agents and “wait” responses to those tasks to complete their own respective tasks. A state-of-the-art multi-agent architecture includes a root agent that engages in conversation with the end user. The root agent identifies sub-tasks related to each user query and then delegates those sub-tasks to other sub-agents, some of which may be individually capable of identifying and delegating still further sub-tasks to lower-level agents. Typically, the user interacts exclusively with the root agent while the lower-level agents process information that is passed to them by the root agent or other higher-level agents.

Within the above-described hierarchal framework of conventional agentic systems, the tasks of higher-level agents are often contingent upon the successful completion of the sub-tasks delegated to lower-level agents. Each time the root agent delegates a task to a lower-level (“child”) agent, the root agent enters a waiting state. If that child agent, in turn, elects to delegate a sub-task of the initial task to its own child (e.g., a grandchild of the root agent), then both the root agent and the child of the root agent remain in the waiting state while the grandchild of the root completes its respective subtask. In this environment, a failure of a lower-level agent can negatively impact the larger system by triggering a chain of failures that propagate up the tree to the root agent, often adding significant latency to total task execution time.

The above-described failure scenario can result in significant inconvenience to a user who is conversing with the root agent in the agentic system. When a lower-level agent experiences a failure, the parent of that lower-level agent is typically responsible for attempting to recover (e.g., by retrying, delegating elsewhere, or handling the failed task itself). This failure detection and retry process induces latencies that can be significant, particularly in scenarios where timeout errors propagate up a chain of agents. For example, a memory failure that causes a lower-level agent to become nonresponsive might not be relayed to a parent agent until after a time-out interval elapses. The elapse of this time-out interval delays task processing because the parent agent does not begin troubleshooting (e.g., be redelegating the task or trying to handle itself) until after the time-out interval has ended. If, in this scenario, the parent agent also encounters a failure (e.g., due to underlying fault that the agent is not equipped to manage) the task may be kicked up to a higher-level agent in a similar manner following elapse of another time-out interval.

In cases where the error handling code does not work as expected, this type of failure can cause the root agent to become unresponsive and stop processing as expected, (e.g., due to waiting for input/output operations that never complete), potentially forcing a restart of the root agent and causing the loss of all user data specific to the chat session. If, for example, the user is interacting with a help agent and has already answered a long series of questions, the user's answers to those questions could be lost when a sub-agent hangs and thereby introduces a system-wide failure, requiring restart of the root agent. In this scenario, the user may be faced with the choice of abandoning their request for help or restarting the entire process and re-answering all previously answered questions anew.

In addition to the above-described issues pertaining to performance stability, state-of-the-art agentic systems are also flawed for lacking adequate safeguards to prevent multi-agent reliance on incorrect information, such as information that has been hallucinated by a language model. Language models use statistics to infer user intent and probabilistically respond. This capability is critical in facilitating realistic bot-led user conversations, but it can lead to problems within environments where multiple agents act on variable values that are the product of statistical inferencing. Assume, for example, that an enterprise provides web-based subscription services with offerings that depend upon the user's country of residence. If a language model is permitted to infer a country of residence for a user based on conversation history with that user (such as based on the language used or geographical information referenced), it is possible that the language model may infer the wrong country of residence at least some small percentage of the time. In this case, an agent might set a “country code” variable to match the incorrectly inferred country of residence. If this incorrectly set variable is then used by other system agents as a basis for other tasks—such as looking up the customer's account number, retrieving relevant subscription or cost information for the user, or scheduling an in-person appointment for the user at a local facility—the workflow is likely to encounter critical errors. Moreover, if personal identity data (PID) is retrieved based on an incorrectly set variable, this could result in a major security breach. For example, using the incorrect country code to retrieve an account number could result in a scenario where the wrong account number is retrieved, and the agent consequently reveals sensitive PID information to an unauthorized party.

Although it is likely that a developer would be inclined to encode safeguards that help mitigate instances where language models are permitted to inferentially set variables that are critical to a workflow, these safeguards are not standardized in any current multi-agent framework and are typically left to developer discretion. For instance, in the above example where the language model determines the country code variable inferentially, the developer may elect to program the agent to cross-check the inferred country code against other information, such as a country associated with the user's internet protocol (IP) address. However, even this rudimentary safeguard depends upon the developer's ability to anticipate foreseeable problems associated with allowing the language model to infer the “country code” variable. Notably, there exist scenarios where developers do not fully anticipate potential errors stemming from variable dependencies. Likewise, it is difficult to anticipate how users are likely to respond to chatbot questions or security breaches that may arise when users provide incorrect information to a conversational interface.

The herein-described technology includes a comprehensive platform for building, deploying, and managing multi-agent applications at scale and in a manner that addresses these and other shortcomings. The disclosed platform sets forth a novel architecture to develop coordinated multi-agent workflows that exhibit much higher performance stability and better security protections than existing systems. Instead of using the above-described hierarchical model with a root agent that converses with the user and delegates sub-tasks to other agents, the herein-disclosed multi-agent architecture employs a flat control structure that lacks parent-child relationships between pairs of the agents. Within this proposed architecture, there are no chains of dependencies between agents. Agents do not delegate tasks to other agents and “await” responses.

Instead of employing the traditional tree-like agent hierarchy for sub-task delegation, the proposed multi-agent architecture includes a plurality of different agents that are each capable of assuming control of the system at different times and conversing with a user or process through a single conversational interface. As used herein, the term “conversational interface” refers to any type of interface that allows people to interact with a computer system using natural language, such as text or voice. The agentic systems described herein employ a conversational interface as a bidirectional communication channel between a user computing system and various agents. As the agentic system transitions between different developer-defined states, different agents assume control of the conversational interface.

Within this framework, a runtime environment stores a state machine that is accessible to and managed by the system agents. The state machine stores various permissible, predefined “states” of the system, with each state being assigned a unique set of agents (referred to herein as an “agent control group”) that controls the conversational interface when the system is in that state. The state machine also defines specific state transitions, with each state transition naming a “former state,” a “new state,” and transition criteria (used herein to refer to either a single criterion or multiple criteria) that, when satisfied while the system is in the former state, causes a transition of the system into the new state. In addition, the definition of a state transition may further define variables that are passed between the set of agents rescinding control of the conversational interface and the set of agents assuming control of the conversational interface as a result of the state transition.

Within this framework, the identity of the agents processing and responding to inputs received through the conversational interface depends, at each point in time, upon the state of the state machine, with the agent control group for the current state being tasked with monitoring system events and evaluating conditions set forth by transition criteria defined with respect to each permissible (developer-defined) state transition. The different system agents have the capability of individually managing the state machine and updating the state of the state machine each time transition criteria are satisfied for one of the predefined state transitions. For example, updating the state of the state machine entails handing off control of the user interface to a new agent control group and providing the new agent control group with structured data outputs that identify both the new state and the former state.

The above-described control structure is referred to herein as a “flat control structure” because there is no delegation of tasks between agents and subagents. This flat control structure is possible due to the use of the state machine to coordinate agent actions and storage of the stage machine within the memory of the different system agents. This flat control structure improves upon the field of agentic workflows in AI systems by eliminating the possibility of single-point faults that cause significant latencies and/or result in loss of user session data. Because each agent works independently and has access to the state machine, the failure of a single agent does not trigger a chain of failures to other higher-level agents (e.g., agents that have paused their respective tasks to “wait” on sub-task results output by lower-level agents).

In scenarios that would cause conventional multi-agent systems to hang indefinitely and crash the root agent (e.g., a single-point system failure as described above), the disclosed state machine framework has no single-fault failure point that could result in a loss of all session data. Instead, each fault is isolated to the state where it occurs, and the agent control group for that state self-responds to the fault by enacting its own retry and recovery mechanisms. In instances where retry and recovery efforts fail, the agent experiencing the fault may potentially retreat to a most recent “checkpoint” in the workflow corresponding to the transition to the current state. From the standpoint of a user interacting with the conversational interface, this type of failure is likely to result in a scenario where the user is asked to re-answer a single (already-answered) question or rephrase a previously-provided answer—all without loss of the user-defined session data stored by other agents before the fault was encountered. The user is, in this scenario, less likely to notice latencies stemming from the fault and not burdened with re-answering a lengthy series of questions that the user has already answered.

In addition to providing more robust performance and improving the user experience in relation to faults that do occur, the disclosed framework for agent-to-agent coordination also reduces faults and security breaches that arise in conventional systems due to model hallucinations that influence agent tasks. This improvement is attributable, at least in part, to a novel declarative data structure that is used when evaluating certain types of variables and conditions that trigger state transitions. According to one implementation, this declarative data structure defines an “evaluation mode” field that dictates whether a specified condition or variable expression is evaluated according to a rule-based evaluation construct (e.g., by a deterministic software tool) or, alternatively, by a prompt-based evaluation construct (e.g., evaluated by a language model). Declaratively requiring certain types of conditions to be evaluated by a rule-based evaluation construct prevents unwanted model inferencing, such as inferencing that might otherwise result due to hallucinated model outputs being passed between agents while at the same time allowing AI inferencing to be selectively used to evaluate other conditions that are less likely to lead to faults (examples of which are described herein).

These and other technical improvements are realized further with references to the figures described below.

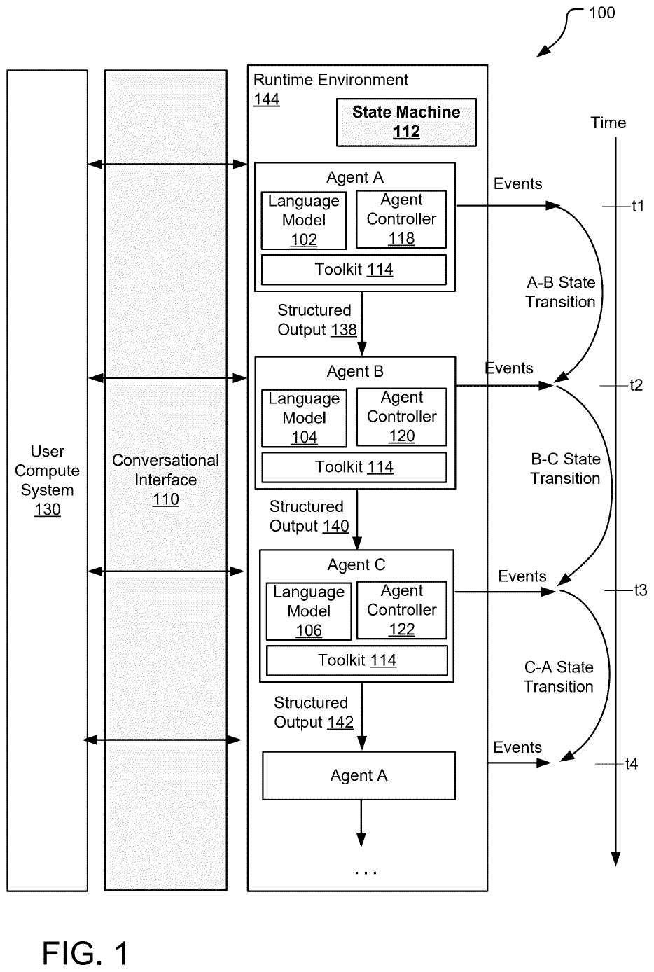

FIG. 1 illustrates aspects of an example agentic system 100 that uses a state machine to coordinate the actions of multiple different agents. Although the agentic system 100 may, in different implementations, include any number of agents, FIG. 1 illustrates three agents—Agent A, Agent B, and Agent C—that work together to perform different actions as part of a coordinated workflow. The agents take turns controlling a conversational interface 110 that receives user queries and other data (e.g., in the form of text, images, audio, or video) from a user compute system 130. When a select one of the agents A-C is in control of the conversational interface 110, the select agent receives inputs through the conversational interface 110, processes the inputs to generate responses, and transmits responses back through the conversational interface 110.

The agents A-C are executed by a runtime environment 144 that manages agent memory, concurrency, message passing, and resource allocation. The runtime environment 144 stores a state machine 112 that is accessible to and controlled (e.g., updated) by the different agents A-C. The state machine 112 defines permissible states of the system and further identifies which agent(s) are in control of the conversational interface 110 when the system is in each different state. In the example shown, the state machine 112 defines at least three system states—State A, State B, and State C. The state definition for each different state identifies the state by name and designates an “agent control group,” which includes the names of agent(s) that receive inputs through the conversational interface 110 when the agentic system 100 is in the given state. In the illustrated example, the agent control group for state A consists of a single agent-Agent A, meaning that Agent A controls the conversational interface 110 when the agentic system is in State A. Likewise, Agent B controls the conversational interface 110 when the agentic system 100 is in State B, and Agent C controls the conversational interface 110 when the system is in State C.

While the agentic system 100 is executing a given workflow that entails processing and answering various queries (and potentially data of other modalities), the agentic system 100 transitions through different predefined states, with each state using a different set of agents (the aforementioned “agent control group”) to process data and/or execute control actions for the system while in the given state. The state machine 112 may be defined in such a way that there is no predefined (fixed) progression of states. For example, individual states can be entered into and transitioned out of multiple times and in various orders during workflow execution with state-to-state transitions depending on events observed within the agentic system 100, such as the contents of queries received via the conversational interface and outputs generated by the various agents and their respective executable subcomponents.

Although not shown, it is contemplated that one or more states of the state machine 112 may have a control group that includes multiple agents. For example, there may exist a defined state, “AB,” in which Agent A and Agent B jointly listen to and control the conversational interface 110, such as by both attempting to answer questions received in this state and/or negotiating which is to answer each query. This may be advantageous when, for example, one or more input queries are closely matched to the capabilities of two or more system agents. If, for instance, one agent can search the internet and another agent is configured to search local documents, there may be times when it is beneficial to dispatch a query to both agents and allow the agents to decide which is equipped to answer the question. For example, the agentic system 100 may have a state named “search” that allows all agents with search capabilities to listen to the conversational interface 110 and optionally respond.

In addition to defining different system states (e.g., State A, State B, State C), the state machine 112 also defines state transitions between pairs of states and transition criteria that, when satisfied, trigger each different one of the state transitions. For example, a transition from State A to State B is triggered when a first predefined event is raised, while a transition from State B to State C occurs when a different predefined event is raised. In this way, control of the conversational interface 110 is handed off between different agent control groups in response to the occurrence of various predefined types of events or events that satisfy predefined conditions.

Each agent in the agentic system 100 includes a language model (e.g., language models 102, 104, 106). The language models within the different agents (A-C) may be the same or different from one another. In embodiments, language models 102, 104, and 106 are generative language models that can process and respond to textual inquiries received through the conversational interface. However, the language models 102, 104, and 106 may be trained on datasets specific to different domains such that the language models can, once trained, provide specialized knowledge in those different domains and/or perform domain-specific tasks. Likewise, the language models 102, 104, and 106 may interface with retrieval augmented generation (RAG) assistants that utilize different source databases to prepare contextual data used by the language models in answering each incoming query.

Consistent with this interpretation, the term “language model” is used herein to refer to a generative machine learning model that is trained to interpret textual inputs representing language. This term is intended to encompass natural language processing (NLP) models as well as multimodal models capable of processing text that does not represent natural language, such as text-based code and textual characters representing images that have been converted into a text-based format. For example, a language model may be a multimodal model that can receive prompts that include text, image, audio, and/or video data and that is capable of generating outputs of one or more types that are not necessarily the same as the input type. Example types of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

In addition to including a language model (e.g., one of the language models 102, 104, and 106), each agent in the agentic system 100 also includes an agent controller (e.g., agent controllers 118, 120, 122) that is stored in agent memory and executed by an agent processing system. Each of the agent controllers 118, 120, 122 stores executable logic for managing the state machine 112, which includes logic for evaluating predefined conditions within the agentic system 100 to raise predefined events, evaluating transition criteria based on satisfaction of the predefined conditions and/or events raised, and updating the state machine 112 to transition between the defined states of the state machine 112 based on satisfaction of different sets of the transition criteria. State machine management (e.g., the aforementioned tasks) is performed by the “active agent control group” meaning, the agent control group that is designated for the current state of the system at a current point in time.

In addition to state machine management logic and logic for controlling the conversational interface 110, the agent controllers 118, 120, and 122 further comprise logic to control a flow of data to and from the agent's language model and to perform various agent-specific control actions on outputs generated by the language model. For example, the agent controller 118 of Agent A receives a user query, generates instructions that indicate how the language model 102 is to process the user query, and passes the instructions and the user query to the language model 102. Additionally, the agent controller 118 includes executable logic for selectively executing tools in a toolkit 114 to process inputs received through the conversational interface 110 or that are generated by the language model.

In FIG. 1, each of the agents A-C in the agentic system 100 is shown storing a different instance of the toolkit 114, which may be understood as a collection of software tools that the agent is permitted to invoke to answer certain types of queries. Examples of tools include a search engine tool, a file search tool, a code-generation tool (e.g., a specialized model separate from the primary language model used by the agent), a code execution tool, and a retrieval augmentation generation (RAG) assistant. In some implementations, different agents within the agentic system 100 store different versions of the toolkit 114 that include different software tools, including tools that are specialized to support the domain-specific functionality of the different agents.

In one implementation, the language models 104, 106, and 108 are equipped with function calling capability, meaning they can construct structured function calls to specific functions that are defined within a “function list” that is passed to the model as input. For example, the agent controller 118 passes the language model 104 a set of inputs that includes a query received through the conversational interface 110, a function list that defines various functions available in the toolkit 114 (e.g., a description of each function as well as how to call the function and the parameters accepted as input), and an instruction to respond to query by optionally invoking a select one of the defined functions when the select function appears likely to be helpful in answering the query. In response to this, the language model 104 may, for example, identify a select function as being potentially helpful in answering the query and respond with a properly formatted function call to a select function defined in the function list corresponding to a tool in the toolkit 114. The properly formatted function call may, for example, include parameters set by the language model 104 to values specified within or otherwise determined based on the query. In response to receiving a function call as output from the language model 104, the agent controller 118 executes the function call to invoke the select function in the toolkit 114. The agent controller 118 then handles the function output by passing it back to the language model 104 (e.g., appending the output to the previously passed query and instructing the model to use the new information to answer the query, if appropriate) or instead returning the output to the user compute system 130 (e.g., in scenarios where the output includes the end result that is sought via the query).

In various implementations, the agentic system 100 includes any number of agents with different skill sets. The purpose and task-processing capabilities of each agent may be partially or fully developer defined. In one implementation, the skill sets of the different system agents are selected by a developer who interacts with a programming interface of a cloud-based agent service platform to design the agentic system 100. For example, the framework provides pre-generated agents that are available for instantiation and/or customization. In one implementation, the developer performs low-code operations via interactions with the user interface that rely on visual tools, drag-and-drop interfaces, and pre-built components to create a system that includes a selection of agents that serve different roles complementary to the purpose of the system being created. The developer may be permitted to customize agent capabilities in various ways, such as by selecting the language model that is used by each different agent, enabling a RAG assistant and populating a RAG index for use by select agents, selecting from a listing of customized tools or providing new tools that different agents can invoke (e.g., customizing or appending to the toolkit 114), and more.

In one implementation that exemplifies a possible combination of agents with different domain-specific areas of expertise, Agent A is an authenticator agent that extracts information from photographic inputs (e.g., picture IDs, thumbprints, retinal scans). To perform this task, Agent A relies on the image processing capability of the language model 102 (e.g., facial recognition, thumbprint-matching, retinal scan-matching) to perform image authentication tasks.

In the same example system, Agent B is a billing agent that retrieves billing information for different customers and is designed to perform tasks related to the billing of an enterprise, such as helping customers with billing questions and facilitating online payments. The language model 104 of Agent B may be a model that is specially trained on documents specific to enterprise billing or, instead, a general-purpose language model that lacks domain-specific training. For instance, the toolkit 114 of Agent B may include a RAG assistant that preprocesses each query received by Agent B to identify relevant data chunks (e.g., excerpts from source documents) residing in a source index that are relevant to the query, with the source index including documents pertaining to subscription information and pricing tiers, including information for different products. Upon receiving each new query, Agent B employs the RAG assistant to identify data chunks relevant to answering the query. The RAG assistant identifies these data chunks and then passes them to the language model 104, along with the query and an instruction to use the relevant data chunks to respond to the query.

Continuing the above example, Agent C may be an external interface agent that is tasked with answering user questions that rely on third-party data residing in one or more databases external to the enterprise implementing the agentic system 100. The language model 108 within Agent C is trained to generate API calls to third-party endpoints that provide services to the user and/or store user data remotely. Agent C stores logic for executing API calls generated by the language model 108, based on user inputs received through the conversational interface 110.

Unlike conventional multi-agent systems that employ a root agent to control a user interface and delegate tasks to lower-level agents, the above-described multi-agent architecture is a flat control structure that does not use a higher-level agent to delegate tasks to lower-level agents. Within this control structure, there are no “parent-child” agent relationships, meaning that there are no agents that “pause” their respective processing tasks (e.g., by entering a waiting state) while waiting on outputs generated by lower-level agents. Instead, the state machine 112 and its respective state transitions define which agent(s) act and control the conversational interface at different points in time. The agents (e.g., A-C) selectively transfer control of the conversational interface among one another in response to transitions of the state machine 112. As used herein, a “selective transfer of control” is said to occur when one a first agent control group (e.g., comprising one or multiple agents) rescinds control of the conversational interface to another agent control group that then assumes the control of the conversational interface. In one implementation, the agents of the system 100 are configured to selectively (e.g., independently and at different times) assume control and rescind control of the conversational interface based on satisfaction of different sets of transition criteria. In FIG. 1, this is illustrated by a timeline that extends vertically, with time progressing forward from the top of the page to the bottom of the page. Per this flow, the system is initialized in a State A—e.g., the default state for a new session. Within state A, certain variables are set by Agent A as messages are exchanged across the conversational interface 110 between Agent A and the user compute system 130.

While the system is in State A, Agent A manages the state machine 112. Managing the state machine 112 includes monitoring messages exchanged through the conversational interface 110, evaluating those messages to assess the satisfaction of conditions requisite for raising various developer-defined events, raising events as appropriate based on the evaluated conditions, monitoring events and evaluating conditions requisite for satisfying the transition criteria defined for the different state transitions, and triggering various state transitions when the corresponding transition criteria are satisfied by the events and/or evaluated conditions.

At a first time, t1, Agent A determines that an event raised satisfies the transition criteria that are defined for a transition from State A to State B. In one implementation, the transition criteria include a developer-defined condition specific to the purpose of State A and State B and/or the domain expertise of the corresponding agent control groups (Agent A and Agent B). For example, in the above-described scenario where State A is an “Authentication State” and State B is a “Billing State,” the transition criteria may provide for transitioning from State A to State B when a “billing question” event is raised. In this case, the state machine 112 includes a definition for an event named “billing question” and the active agent control group raises the event each time a question is received that pertains to billing. This evaluation can be conducted by the agent controller 118 in various ways, such as by applying a predefined (static) rule such as a rule, invoking a function from the toolkit 114 to deterministically evaluate the query, or instructing the language model 102 to indicate whether the query pertains to billing. An example of a static rule includes a rule that provides for raising a certain type of event (e.g., a “billing question” event) when a query includes a keyword from a particular list.

When Agent A determines that the transition criteria have been satisfied for the A-to-B state transition, Agent A passes a set of structured outputs 138 to Agent B (the designated agent control group for State B). In one implementation, the set of structured outputs 138 includes information for identifying the state transition that has occurred and the runtime environment 114 updates the state of the state machine 112 based on the structured outputs 138. Additionally, the set of structured outputs 138 may include local variables that have been set by Agent A and that are specifically identified within the state machine 112 as requisite inputs to Agent B upon entry into State B. If, for example, the transition is predicated upon the most recent user query satisfying some criterion, the received query may be included as a “message” variable that is passed from Agent A to Agent B during this transition. When the A-to-B transition occurs at time t1, the agent control group of state A (e.g., Agent A) rescinds control of the conversational interface 110, and the agent control group of state B (e.g., Agent B) assumes control of the conversational interface. If the set of structured outputs 138 includes a “message” variable storing an unanswered query from the user compute system 130, the agent control group of the new state (Agent B) proceeds to process and answer that unanswered query.

The states define logical execution checkpoints of each workflow. Following the transition to each new state (e.g., State B), variables defined during the former state (e.g., State A) remain stored within the state machine 112 of the agent control group for the former state (e.g., Agent A) and are not updated at that location until a new instance of the former state is commenced. This duplicate variable storage across agent control groups before/after each state transition is important in error recovery because it prevents single-point failures in a multi-agent workflow by facilitating a rollback of the entire system to the temporal checkpoint corresponding to the last state transition. If, for example, Agent B encounters a failure that causes it to become nonresponsive an extended period of time, error-handling code within the agent controller 120 can force a restart of Agent B, which triggers a “repeat” of the last state-to-state transition-effectively resetting the system and all variables to values assumed at time t1. When this rollback occurs, Agent A again passes the same set of structured outputs 138 to Agent B, and Agent B resumes processing from the point in time following this transition. This isolates potential user data loss to the variables defined locally by Agent B prior to the restart.

While in State B, Agent B manages the state machine 112 by performing the operations generally described above with respect to State A, including monitoring messages exchanged through the conversational interface 110, evaluating those messages to assess satisfaction of conditions requisite for raising events, raising events as appropriate, continuously re-evaluating whether the transition criteria are satisfied with respect to any of the permitted state-to-state transitions (e.g., by monitoring the raised events and evaluating other conditions set forth within the transition criteria), and triggering a state-to-state transition in response to determining that the corresponding transition criteria are satisfied

Upon determining that the transition criteria have been satisfied for a B-to-C transition at a time t2, Agent B updates the state of the state machine (e.g., by updating a global “State” variable) by passing a set of structured outputs 140 to Agent C, which is the designated agent control group for State C. The set of structured outputs 140 includes information for identifying the state transition that has occurred (e.g., an A to B state transition) and the runtime environment 144 updates the state of the state machine 112 accordingly. Additionally, the set of structured outputs 140 may include other variables defined by the state machine 112 as requisite “outputs” from Agent B each time the system transitions from State B to another state. These other variables may, for example, include local variables set by Agent B or otherwise known to Agent B, such as variables set by Agent A within the initial instance of State A that are passed to Agent B as part of the set of structured outputs 138.

In response to passing the set of structured outputs 140 to Agent C, Agent B rescinds control of the conversational interface 110, and Agent C (e.g., the designated agent control group for State C) assumes control of the conversational interface 110. Agent C then begins managing the state machine 112 as described above with respect to State A and State B. At time t3, Agent C determines that the transition criteria have been satisfied for a C-to-B transition. In response to this determination, Agent C updates the state of the state machine (e.g., by updating the “State” variable) and passes another set of structured outputs 142 to the agent control group of the new state (e.g., Agent A), which assumes control of the conversational interface 110 and again begins managing the state machine 112 until a next state transition occurs (e.g., at time t4).

Although the illustrated example uses an alphabetical progression to indicate an order of states (A to B to C and back to A), the state machine 112 may support transitions between any two states based on events that occur in any order. For example, rather than transitioning from A to B to C, the agentic system 100 could alternatively transition from A to C to A to C to B to C, etc. Permissible state transitions are developer-defined along with the corresponding transition criteria and the variables that are passed within the structured output that flows between the agent control groups of former and new states associated with each state transition. The above-described architecture facilitates the deployment of highly scalable systems that exhibit greater fault tolerance than conventional systems due to the aforementioned “rollback” capability that allows any active workflow to experience a fault, restart the agent that experienced the fault, and then resume the workflow from an earlier checkpoint corresponding to the most recent state-to-state transition.

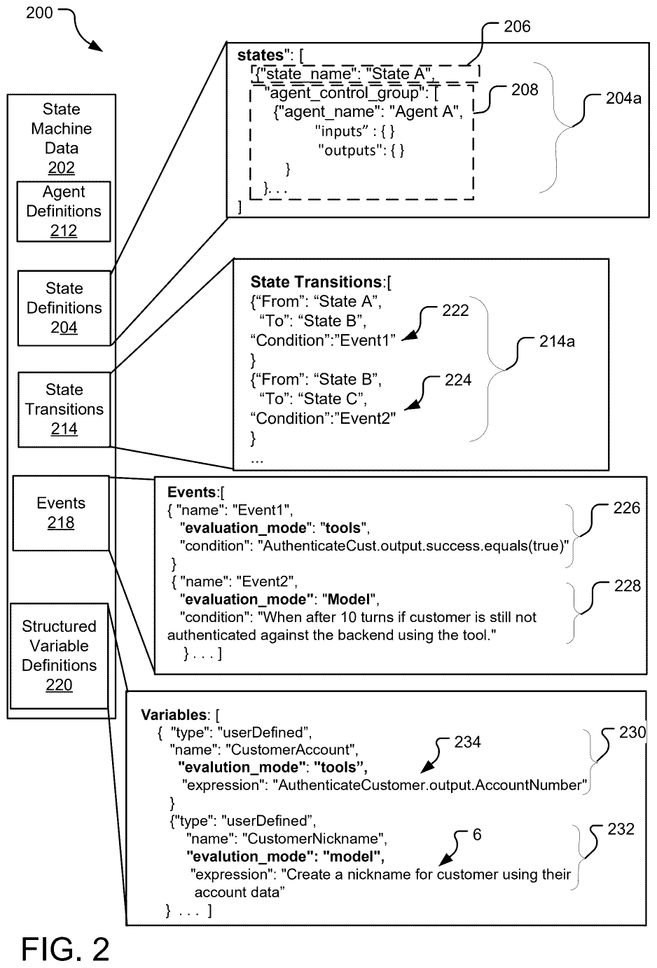

FIG. 2 illustrates example state machine data 202 that is stored as part of a state machine used to coordinate multi-agent workflows in an example agentic system 200. In one implementation, a developer defines the state machine data 202 by interacting with a programming interface of a cloud-based agent service platform. Through the programming interface, the developer defines a set of agents, stored as agent definitions 212. For example, the developer selects predefined agents for instantiation and/or customizes different predefined agent templates for inclusion in the same agentic system. Customization of a predefined agent template may, for example, include selecting tools, models, and resources available to the agent and/or defining specific functions that the agent is directed to carry out upon receipt of select variables.

Each of the agent definitions 212 identifies at least a primary language model that the agent is to use to process inputs received through the conversational interface, as well as a bundle of software tools that are to be included within the agent and optionally invoked, by the agent, to process received inputs or data by the agent itself (e.g., data generated by the language model or other tools).

In addition to agent definitions 212, the state machine data 202 also includes state definitions 204. In one implementation, a developer defines the state definitions 204 within the above-described programming interface of the cloud-based agent service platform. As exemplified by state definition block 204a, each of the state definitions 204 includes at least a state name (e.g., a state name 206) and an agent control group definition 208 that designates a set of agents (meaning, one or more agents) responsible for acting on inputs received through a conversational interface while the state machine is in that state.

For example, when the system is in State A, the agent control group of State A is responsible for managing the state machine, listening to the conversational interface, processing data received through the user interface, and acting on the data, such as by generating and returning responses through the conversation interface or by executing control actions that carry out instructions included in the received data. In the example shown, the agent control group definition 208 additionally identifies input variables that are passed to respective agents in the agent control group upon entry into the state and output variables that are output by respective agents in the agent control group as part of a transition out of the state. It is assumed that the input and output variables referenced within the state definitions 204 are defined among structured variable definitions 220 of the state machine, the contents of which are discussed in greater detail below.

In FIG. 2, the state definition block 204a is simplified for clarity of concept and identifies a single state, with the state name 206 of “State A.” The state definition for state A includes the agent control group definition 208, which in this case names “Agent A” as the sole agent that is responsible for acting while the agentic system 200 is in State A. The definition also identifies structured input variables passed to Agent A upon entry into State A and structured output variables that are output by Agent A and passed to the agent control group of a new state when the agentic system 200 transitions out of State A. Although not shown, it is assumed that the state definitions 204 include similarly formatted state definition blocks for one or more additional states, including at least State B and State C, which are referenced in a state transition code block 214a described below.

In addition to the agent definitions 212 and the state definitions 204, the state machine data 202 also includes state transitions 214. Like the state definitions 204, the state transitions 214 are developer-defined by interacting with the programming interface of the cloud-based agent service platform. The state transitions 214 define pairs of states that the agentic system is permitted to transition between while executing a workflow as well as the criteria (“transition criteria”) that, when satisfied, trigger each state transition. As shown by the state transition code block 214a, each state transition identifies the name of the former state that the agentic system 200 is transitioning out of and the name of a new state that the agentic system 200 is transitioning into. Additionally, each state transition identifies transition criteria that include at least one transition condition.

As used herein, the term “transition criteria” refers to one or more conditions defined with respect to a state transition that, when satisfied while the agentic system 200 is in the former state identified by that state transition, triggers the state transition. Transition criteria can include conditions requisite for raising developer-defined event(s) or condition(s) that do not reference or depend upon developer-defined events. For example, a state transition may hinge upon the occurrence of a developer-defined event, “Event1” (which has a declarative data structure stored among events 218), or instead upon a condition that is not defined in the events 218. For example, transition criteria for a state condition are satisfied whenever a particular function outputs a “true” result.

By example, the state transition code block 214a defines two different permissible state transitions, each of which is triggered by the occurrence of a different type of developer-defined event. The first illustrated state transition is a transition between State A and State B that is conditioned on first transition criteria that consists of a first transition condition 222. The first transition condition 222 is satisfied when the active agent control group of State A raises an event of a first predefined type named “Event1.” The second illustrated state transition is a transition between State B and State C that is conditioned on second transition criteria that includes a second transition condition 224. The second transition condition 224 is satisfied when the active agent control group of State B raises an event of a second predefined type, named “Event2.” Both developer-defined events are stored among the state machine data 202, e.g., within a data block labeled “events 218,” which is discussed in further detail below.

In the agentic system 200, transition conditions may be defined using a declarative data structure that includes a field defining an “evaluation mode.” The evaluation mode dictates whether the transition condition is evaluated according to a rule-based evaluation construct or a prompt-based evaluation construct. This concept is illustrated in greater detail below with respect to the data block that is labeled as “events 218.”

Each of the events 218 is a structured variable defined based on at least three data fields: event name, evaluation mode, and condition. In FIG. 2, two instances of this data structure are shown with respect to a first event 226, and a second event 228, respectively. The event name is a unique identifier for the event that is used to reference the event within the state transitions 214 (e.g., Event1). The condition field for each of the events 218 defines a condition that must be satisfied for the event to be raised. In a scenario where an instance of the event triggers a state condition (e.g., Event1 triggers a transition from State A to State B), this condition defined for the event also represents the transition condition for the state transition that depends upon that event. The evaluation mode field for each of the events 218 identifies a valid method for evaluating the condition,

In the agentic system 200, there exist two valid evaluation modes for conditions. By example, these modes are named “tools” and “model,” respectively. The first evaluation mode, “tools,” represents a rule-based evaluation construct. When the evaluation mode is set to “tools,” the corresponding condition is evaluated deterministically. A condition is said to be evaluated deterministically when there is no uncertainty or randomness in the evaluation, meaning the evaluation always returns the same result when operating on the same set of inputs. Examples of deterministic evaluations include evaluations that are conditioned by applying rules or sets of rules (mathematical algorithms), calculations, logic-based systems, and simulations without randomness.

In the agentic system 200, the first event 226 has the evaluation mode set to “tools” (the deterministic evaluation construct), meaning that the condition for the first event 226 is evaluated deterministically—e.g., by executing the condition to invoke a software tool included in a toolkit accessible to each individual agent defined within the agent definitions 212.

In contrast to this, the second evaluation mode illustrated in FIG. 2 is named “model” and represents a prompt-based evaluation construct. When the evaluation mode is set to “model,” the corresponding condition is evaluated using a language model (e.g., the primary language model of the agent, as shown in FIG. 1). The language model is passed a prompt that identifies the condition, and the language model employs its statistical inferencing capability to evaluate the condition. This type of condition evaluation is probabilistic rather than deterministic because generative language models use probabilistic reasoning rather than fixed rules to generate output tokens. Consequently, it is possible for a language model to produce different outputs for the same input depending on context or randomness. If, for example, a language model is prompted twice with the prompt “Write a poem about the moon,” it is entirely possible that the language model will output two different poems in response to the same prompt. In the example shown, the second event 228 has the evaluation mode set to “model” (the prompt-based evaluation construct), meaning that the condition for the second event 228 is evaluated probabilistically—e.g., by passing the condition as an input to a language model.

Notably, there exist scenarios where a developer may prefer a condition to be evaluated probabilistically by a language model as opposed to deterministically by a software tool. If, for instance, the developer defines a state transition that is contingent upon the user's conversational veering toward a particular topic, it is much simpler and more effective to use the language model's understanding of semantic relations to evaluate whether the user's query includes a keyword that is semantically related to the topic that triggers the state transition than it is for the developer to encode a deterministic function to make the same determination.

Alternatively, in scenarios where the condition being evaluated is critical to the multi-agent workflow, the performance of the agentic system 200 can be improved by forcing a deterministic evaluation of the condition. If, for example, the condition being evaluated represents a critical workflow checkpoint, a probabilistic evaluation of the condition could introduce a security breach or a fault that breaks the workflow. Assume, for example, that a particular workflow (e.g., user-requested task) is, for security reasons, contingent upon the condition of “successful customer authentication.” Forcing a deterministic evaluation of this condition eliminates the possibility of the agentic system 200 completing the workflow for a customer that has not, in fact, been authenticated (e.g., because the deterministic evaluation eliminates the possible influence of model hallucinations and randomness that could lead to an incorrect determination of the “successful customer authentication” condition).

Within conventional multi-agent systems, it is common for agents to use language models to evaluate conditions. However, there is no existing mechanism that allows a developer to easily hide a conditional statement from a language model to prevent the probabilistic reasoning of the model (e.g., hallucinations and randomness) from affecting the evaluation of the condition. The above-described declarative data structure addresses this need by introducing the evaluation mode field, as shown within the example events 226 and 228. This data structure provides a developer with a standardized, scalable framework for using the language model to evaluate some conditions while “hiding” other conditions from the language model and instead evaluating those conditions deterministically. Using the above-described declarative data structure to set an evaluation mode for a condition simplifies the task of hiding certain condition evaluation tasks from the language model when the values of those conditions can be evaluated deterministically by system tools (e.g., or when those values have already been evaluated deterministically and stored as structured variable data). This, in turn, improves system performance by ensuring critical workflow checkpoints are evaluated deterministically.

In addition to the data types described above, the state machine data 202 further includes defines various structured variables, which are represented within the data block labeled “structured variable definitions 220.” These structured variables are used to store values that may be passed between agents during state transitions. For example, the state definition block 204a defines “inputs” that are passed to Agent A (the agent control group for State A) during a state transition into State A from another state. The state definition block 204a also defines the “outputs” that are passed as output by Agent A during transitions out of State A. These input and output variables referenced (e.g., by name) in the state definition block 204a are defined within the structured variable definitions 220. As used herein, a structured variable refers to a variable that holds multiple related values organized in a specific format or structure rather than just a single data item.

In the illustrated example, structured variables 230 and 232 store values for fields titled “data type,” “name,” “evaluation mode,” and “expression.” For both of these variables, the data type field is set to “UserDefined,” which indicates that these variables are defined by the developer rather than by the cloud-based agent service platform. The “name” field is used to provide the variable with a unique identifier, while the “expression” field stores an expression that is used to assign a value to the variable. For example, the expression is an executable expression that returns a value for the variable or a natural language instruction that can be passed to a language model to cause the language model to determine a value for the variable. Finally, the “evaluation mode field stores a value that functions to restrict how the “expression” is evaluated—whether the expression is evaluated deterministically or probabilistically.

In the agentic system 200, the available values for the “evaluation mode” field of each structured variable are identical to the values described above with respect to the evaluation modes used to evaluate conditions. These modes include the “tools” mode that implicates a rule-based (deterministic) evaluation construct and a “model” mode that implicates a prompt-based (probabilistic) evaluation construct. When the evaluation mode of a structured variable is set to “tools,” the variable is effectively hidden from the language model of the agent control group, and the variable is instead set using a deterministic software tool to evaluate the expression. Alternatively, when the evaluation mode of a structured variable is set to “model,” the variable is evaluated by a language model. Specifically, the language model is prompted to execute and respond to the natural language instruction that is stored in the “expression” field of the variable definition.

Like events and state transitions, there exist scenarios where it is beneficial to use language models to set certain non-critical variables while requiring other workload-critical variables to be set deterministically. For instance, the expression 234 defines a variable “CustomerAccount” that stores a customer account number. Setting this variable incorrectly (e.g., based on a model hallucination) could result in a security breach or failure of the workload entirely. For example, a security breach may occur if the CustomerAccountID is set to an incorrect value that is subsequently used to pull account data that the user should not have access to. Alternatively, the agentic system 200 may experience a critical fault if the system attempts to use the CustomerAccount ID to locate necessary information and cannot find such information because the account number is wrong. For this reason, it is more desirable to use a deterministic evaluation methodology to verify and set the CustomerAccountID variable.

In contrast, there likewise exist instances where probabilistic inferencing capability is preferred over deterministic variable evaluation. For example, the structured variable definition 232 defines a variable “Customer Nickname” that is to be used by system agents to informally address a customer during a conversation with the customer. This variable is set by prompting a language model to evaluate the expression “create a nickname for the customer using their account data” (presumably, some user account data is also passed to the language model with this instruction). In this case, the “CustomerNickname” variable is non-critical because the system agents do not rely on this value to perform workload-critical tasks that would cause the workload to fail if based on incorrect data. Allowing the language model to set the “CustomerNickname” variable simplifies the workflow without lowering the likelihood of successful workload execution.

In sum, the declarative data structure shown with respect to the structured variables definitions 230 and 232 enhances security within a multi-agent framework by ensuring that critical variables are set deterministically while also allowing the developer to leverage the semantic inferencing capabilities of language models to set non-critical variables that are difficult or onerous to set via deterministic solutions.

Although not shown, the structured variable definitions 220 may define other types of variables in addition to “UserDefined” variables. In one implementation, the agentic system 200 supports “Message” and “Thread” data types in addition to “UserDefined” data types. A “message” data type is a data type storing a message sent across the conversation interface. When supported, the “message” datatype can be used to influence what input prompt a given agent gets when activated or to capture the response of an agent after their turn is complete. In contrast, the “Thread” data type is a data type used to define variables corresponding to containers for messages exchanged through the conversational interface (e.g., input by a user and output by one or more agents). A thread serves as a shared space where both customer and agent messages are stored. In one implementation, different threads can be configured and selectively shared between select subsets of agents. This data type allows threads to be shared between one or more agents, enabling messages to be shared by reference.

Once the developer has defined the state machine data 202 as generally described above, the cloud-based agent service platform deploys the developer-defined agentic system by providing a runtime environment (e.g., using cloud-based resources) that includes a conversational interface that receives inputs from a user computing system. Within the runtime environment, the cloud-based agent service platform initializes the plurality of agents that are defined within the agent definitions 212, with each initialized agent being configured to access state machine state that is stored within the runtime environment, including the state definitions 204, the state transitions 214, the events 218, and the structured variable definitions 220. Additionally, each agent stores logic for managing a state machine according to the conditions, events, and state transitions defined by the state machine data 202, as generally described with respect to FIG. 1.

In one implementation, the above-described orchestration capabilities supporting agentic workflows are provided by Foundry Definition Language (FDL). Customers interact with a web portal (e.g., Azure AI Foundry portal) to define state machine data and to manage configurations for deploying agentic workflows in FDL.

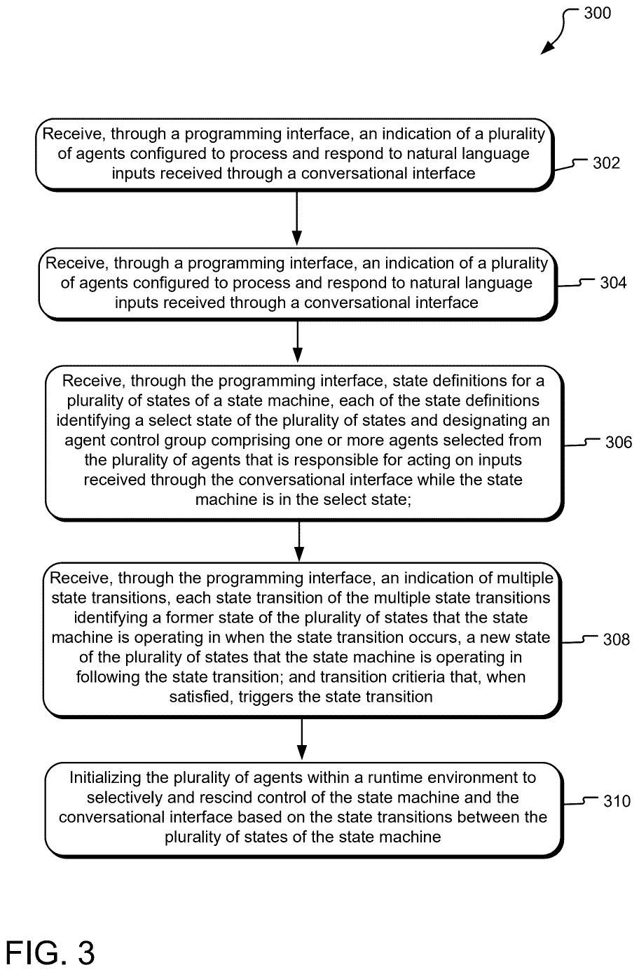

FIG. 3 illustrates example operations 300 for providing a multi-agent workflow. Within this flow, a receiving operation 302 receives, through a programming interface, an indication of a plurality of agents configured to process and respond to natural language inputs received through a conversational interface. Each of the agents includes a language model and a software toolkit for operating on language model outputs and on data received through the conversational interface. In one implementation, the agents are coded or designed by the provider of a cloud-based agent service platform and made available for selection and/or customization via a programming interface of the cloud-based agent service platform. For example, a developer provides the indication of the plurality of agents by selecting and/or customizing an agent (or agent templates) provided by the cloud-based agent service platform. Customization may, for example, include selecting the identity of the language model included in each agent, the contents of the software toolkit included in each agent, or other characteristics.

Another receiving operation 304 receives state definitions through the programming interface. The state definitions define a plurality of states of a state machine. Each of the state definitions identifies a select state of the plurality of states and designates an agent control group comprising one or more agents selected from the plurality of agents. The agent control group is responsible for acting on inputs received through the conversational interface while the state machine is in the select state. In one implementation, state definitions are developer-defined through the programming interface of a cloud-based agent service platform that provides the agents, as generally described above.

Still, another receiving operation 306 receives state transition definitions that identify permissible transitions between pairs of the plurality of states. Each one of the state transition definitions identifies a former state of the plurality of states that the state machine is operating in when a state transition occurs, a new state of the plurality of states that the state machine is operating in following the state transition; and transition criteria that, when satisfied, triggers the state transition. The state transition definitions are, for example, developer-defined through interactions with the above-described programming interface of the cloud-based agent service platform.

A runtime initialization operation 308 initializes the plurality of agents within a runtime environment in which various of the plurality of agents selectively assume and rescind control of the state machine and the conversational interface based on the permissible transitions between states of the state machine. Each time a state transition occurs; the control of the user interface and the state machine is transferred according to a flat control structure that lacks parent-child relationships between pairs of the plurality of agents.

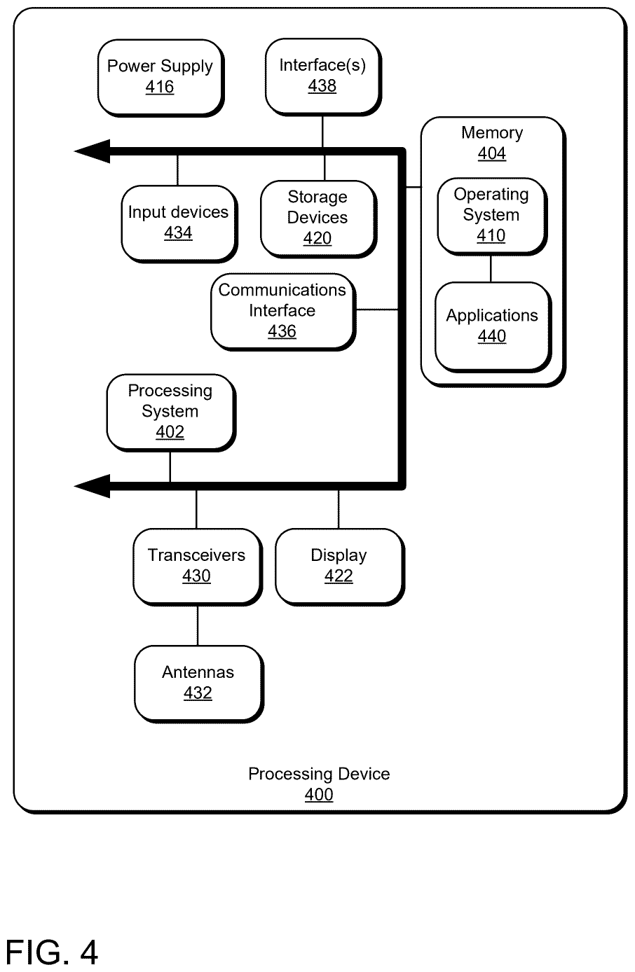

FIG. 4 illustrates an example schematic of a processing device 400 suitable for implementing aspects of the disclosed technology. The processing device 400 includes a processing system 402, memory 404, a display 406, and other interfaces 408 (e.g., buttons). The processing system 402 may include one or more CPUs, GPUs, etc. The processing device 400 may be a client computing device (such as a laptop computer, a desktop computer, or a tablet computer), a server/cloud computing device, an Internet-of-Things (IoT), any other type of computing device, or a combination of these options.

The memory 404 generally includes both volatile memory (e.g., RAM) and nonvolatile memory (e.g., flash memory), although one or the other type of memory may be omitted. An operating system 410 resides in the memory 404 and is executed by the processing system 402. In some implementations, the processing device 400 includes and/or is communicatively coupled to storage 420.

In the example processing device 400, as shown in FIG. 4, one or more software modules, segments, and/or processors, such as applications 450 (e.g., language models, AI agents, and toolkit applications (e.g., toolkit 114 of FIG. 1) are loaded into the operating system 410 on the memory 404 and/or the storage 420 and executed by the processing system 402. The storage 420 may state machine data that includes agent definitions, state definitions, permissible state transitions, developer-defined events, and structured variable definitions.

The processing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The processing device 400 may further include a communications interface 436 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the processing device 400 and other devices may be used.

The processing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The processing device 400 may further include a display 422, such as a touchscreen display.

The processing device 400 may include a variety of tangible processor-readable storage media and intangible processor-readable communication signals. Tangible processor-readable storage can be embodied by any available media that can be accessed by the processing device 400 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the processing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method of providing a multi-agent workflow, the method including:
receiving, through a programming interface, an indication of a plurality of agents configured to process and respond to natural language inputs received through a conversational interface:
receiving, through the programming interface, state definitions for a plurality of states of a state machine, each of the state definitions identifying a select state of the plurality of states and designating an agent control group comprising one or more agents selected from the plurality of agents that is responsible for acting on inputs received through the conversational interface while the state machine is in the select state;
receiving, through the programming interface, state transition definitions that each identify:
a former state of the plurality of states that the state machine is operating in when a state transition occurs;
a new state of the plurality of states that the state machine is operating in following the state transition; and
transition criteria that, when satisfied, triggers the state transition; and
initializing the plurality of agents within a runtime environment to selectively transfer control of the conversational interface among one another based on transitions between states of the state machine, the control of the conversational interface being transferred according to a flat control structure that lacks parent-child relationships between pairs of the plurality of agents.

2. The method of claim 1, wherein the state machine is updated at a given instance in time by the agent control group that is designated for a state that the state machine is in.

3. The method of claim 1, wherein each of the plurality of agents includes logic for updating the state machine and a language model for processing messages received through the conversational interface.

4. The method of claim 1, wherein the transitions between states include a state transition between a first state of the plurality of states and a second state of the plurality of states includes passing structured data outputs between the agent control group for the first state and the agent control group for the second state, wherein the structured data outputs identify the first state and the second state.

5. The method of claim 1, wherein the transition criteria for a select one of the state transitions further identifies an evaluation mode that dictates whether the transition criteria are evaluated according to a rule-based evaluation construct or a prompt-based evaluation construct.

6. The method of claim 5, wherein the transition criteria are evaluated according to a deterministic rule or set of rules when the evaluation mode identifies the rule-based evaluation construct, and wherein the transition criteria are evaluated by a language model when the evaluation mode identifies the prompt-based evaluation construct.

7. The method of claim 5, wherein each of the plurality of agents includes a language model, a software toolkit, and executable logic for selectively invoking either the language model or a tool in the software toolkit to evaluate the transition criteria for the state transition based upon the evaluation mode that is identified for the transition criteria.

8. The method of claim 1, further comprising: receiving, through the programming interface, structured variables that are each defined via a declarative data structure that includes an expression for assigning a value to a variable and an evaluation mode for evaluating the expression, wherein the evaluation mode indicates whether the variable is assigned deterministically as a result of a rule-based evaluation construct or probabilistically as a result of prompt-based evaluation construct.

9. The method of claim 1, wherein each state of the plurality of states further identifies:
a set of structured inputs passed to the agent control group of the state in response to a transition into the state; and
a set of structured outputs that are output by the agent control group of the state in response to a transition out of the state.

10. A system comprising:
a processing system;
a conversational interface for receiving inputs from a user computing system;
a plurality of agents stored in memory and executable by the processing system to control a state machine and to selectively assume and rescind control of the conversational interface based on transitions between a plurality of states of the state machine; and
state machine data defining the state machine, the state machine data being stored within memory accessible to each of the plurality of agents and defining at least:
the plurality of states of the state machine, each state of the plurality of states having a designated an agent control group comprising one or more agents selected from the plurality of agents that is responsible for acting on inputs received through the conversational interface while the state machine is in the state; and
multiple state transitions, each state transition of the multiple state transitions identifying:
a former state of the plurality of states that the state machine is operating in when the state transition occurs;
a new state of the plurality of states that the state machine is operating in following the state transition; and
transition criteria that, when satisfied, triggers the state transition.

11. The system of claim 10, wherein the state machine is updated at a given instance in time by the agent control group that is designated for a state that the state machine is in at the given instance in time, and wherein the control of the conversational interface and the state machine is transferred according to a flat control structure that lacks parent-child relationships between pairs of the plurality of agents.

12. The system of claim 10, wherein each of the plurality of agents includes a language model for processing messages received through the conversational interface.

13. The system of claim 10, wherein executing a state transition between a first state of the plurality of states and a second state of the plurality of states includes passing structured data outputs between the agent control group for the first state and the agent control group for the second state, wherein the structured data outputs identify the first state and the second state.

14. The system of claim 10, wherein the transition criteria for a select one of the multiple state transitions further identifies an evaluation mode that dictates whether the transition criteria are evaluated according to a rule-based evaluation construct or a prompt-based evaluation construct.

15. The system of claim 14, wherein the transition criteria are evaluated according to a deterministic rule or set of rules when the evaluation mode identifies the rule-based evaluation construct, and wherein the transition criteria are evaluated by a language model when the evaluation mode identifies the prompt-based evaluation construct.

16. The system of claim 14, wherein each of the plurality of agents includes a language model, a software tool kit, and executable logic for selectively invoking either the language model or a tool in the software tool kit to evaluate the transition criteria for the state transition based upon the evaluation mode that is identified for the transition criteria.

17. The system of claim 10, wherein the state machine data further includes structured variables that are each defined via a declarative data structure that includes an expression for assigning a value to a variable and an evaluation mode for evaluating the expression, wherein the evaluation mode indicates whether the variable is assigned deterministically as a result of a rule-based evaluation construct or probabilistically as a result of prompt-based evaluation construct.

18. One or more tangible processor-readable storage media encoding processor-executable instructions for executing a computer process, the computer process comprising:
instantiating a plurality of agents configured to process and respond to natural language inputs received through a conversational interface, each agent of the plurality of agents being configured to selectively transfer control of the conversational interface among one another based on transitions between a plurality of states of a state machine, the state machine being defined by state machine data identifying:
an agent control group that is responsible for acting on inputs received through the conversational interface while the state machine is in each of the plurality of states, the agent control group comprising a subset of the plurality of agents; and
multiple state transitions between pairs of the plurality of states, each state transition of the multiple state transitions identifying:
a former state of the plurality of states that the state machine is operating in when the state transition occurs;
a new state of the plurality of states that the state machine is operating in following the state transition; and
transition criteria that, when satisfied, triggers the state transition.

19. The one or more tangible processor-readable storage media of claim 18, wherein the state machine is updated at a given instance in time by the agent control group that is designated for a state that the state machine is in at the given instance in time, and wherein the control of the state machine is transferred according to a flat control structure that lacks parent-child relationships between pairs of the plurality of agents.

20. The one or more tangible processor-readable storage media of claim 18, wherein the transition criteria for a select one of the multiple state transitions further identifies an evaluation mode that dictates whether the transition criteria are evaluated according to a rule-based evaluation construct or a prompt-based evaluation construct.
